(19) United States
(12) Patent Application Publication
(10) Pub. No.: US 2016/0162186 A1
(43) Pub. Date: Jun. 9, 2016

(54) Re-Ordering NAND Flash Commands for Optimal Throughput and Providing a Specified Quality-of-Service

(71) Applicant: San Disk Technologies Inc., Plano, TX (US)

(72) Inventors: Manohar Kashyap, Milpitas, CA (US); Tucker Berckmann, Palo Alto, CA (US); Jian Zhao, Castro Valley, CA (US)

(21) Appl. No.: 14/565,241

(22) Filed: Dec. 9, 2014

(51) Int. Cl. G06F 3/06

(52) U.S. Cl. CPC G06F 3/061; G06F 3/0688; G06F 3/0659

(57) ABSTRACT

Techniques are presented to help keep all possible independent-NAND-access-channels busy even when the traffic from the host is not arriving evenly. Incoming commands from a flash translation layer for a device are directed by a command issuer to separate queues for admin (device management), reads, writes, erases and, in the exemplary embodiment, high-priority reads. A queue-picker can then switch between various command queues, where individual read, write and erase queues for a device can be further divided into die-based queues. A complementary set of techniques provide a certain level of performance, termed as Quality-Of-Service (QoS), by implementing QoS in terms of physical addresses. The flash translation layer, which has access to information on the physical addresses typically hidden from the host, is used for optimizing and guaranteeing input/output (I/O) access times

### BACKGROUND

This application relates to the operation of re-programmable non-volatile memory systems such as semiconductor flash memory and to the ordering of the commands issued for such systems.

A host computer issues commands to a NAND storage device, such as a solid state storage device (SSD), without knowledge of the internals of the device. This may result in read/write traffic being unevenly distributed among various dies/planes/chips within the NAND storage device, keeping some dies/planes/chips busier than others, reducing the overall throughput. Consequently, such storage devices could benefit from techniques that could keep the different memory access channels busy even when the traffic from the host is not arriving evenly.

### SUMMARY

Methods are presented for operating a non-volatile memory system that including one or more non-volatile flash memory circuits. A series of commands each specifying a physical address is received on the non-volatile memory, the series of commands including read, write and erase commands for the specified physical addresses. The received series of commands are arranged into a plurality of queues for execution thereof, where separate queues are maintained for read commands, write commands, and erase commands. Sequences of commands to execute are selected from the plurality of queues, where only one of the queue is active at a time, and transmitted to the one or more non-volatile memory circuits to be executed.

Methods are also presented for a non-volatile memory system to provide access for a plurality of user applications to a non-volatile data storage section. The method includes receiving from the plurality of user applications requests for accessing corresponding user partitions of the data storage section as assigned by the memory system, wherein each of the user applications has a specified level of performance and availability for the accessing the corresponding user partition, and wherein the user application requests are specified in terms of corresponding logical addresses. The specification of the user application requests in terms of corresponding logical addresses is translated to be expressed in terms of corresponding physical addresses for the non-volatile data storage section. The method arbitrates between requests from different ones of the user applications based upon the requests' corresponding physical addresses and corresponding specified levels of performance and availability to determine an order in which to execute the user application requests. Instructions are issued for the execution of the user application requests based upon the determined order.

Various aspects, advantages, features and embodiments are included in the following description of exemplary examples thereof, which description should be taken in conjunction with the accompanying drawings. All patents, patent applications, articles, other publications, documents and things referenced herein are hereby incorporated herein by this reference in their entirety for all purposes. To the extent of any inconsistency or conflict in the definition or use of terms between any of the incorporated publications, documents or things and the present application, those of the present application shall prevail.

### BRIEF DESCRIPTION OF THE DRAWINGS

FIG. 1 illustrates schematically the main hardware components of a memory system suitable for implementing various aspects described in the following.

FIG. 2 illustrates schematically a non-volatile memory cell.

FIG. 3 illustrates the relation between the source-drain current I_{D} and the control gate voltage V_{CO} for four different charges Q1-Q4 that the floating gate may be selectively storing at any one time at fixed drain voltage.

FIG. 4 illustrates schematically a string of memory cells organized into a NAND string.

FIG. 5 illustrates an example of a NAND array 210 of memory cells, constituted from NAND strings 50 such as that shown in FIG. 4.

FIG. 6 illustrates a page of memory cells, organized in the NAND configuration, being sensed or programmed in parallel.

FIGS. 7A-7C illustrate an example of programming a population of memory cells.

FIG. 8 shows an example of a physical structure of a 3-D NAND string.

FIGS. 9-12 look at a particular monolithic three dimensional (3D) memory array of the NAND type (more specifically of the “BiCS” type).

FIG. 13 gives a system overview for an exemplary embodiment.

FIG. 14 shows a command queue (say read queue) organized as individual plane queues.

FIG. 15 illustrates a state machine of the queue picker.

FIG. 16 is an example showing how synchronization primitives can be handled by maintaining a set of flags.

FIG. 17 shows the use of hash tables keep track of pending writes/erases to the same PBA as incoming request.

FIG. 18 illustrates re-ordering and the use of SYNC boundaries.

FIG. 19 illustrates Quality-of-Service (QoS) at the physical block address (PBA) layer.

### DETAILED DESCRIPTION

### Memory System

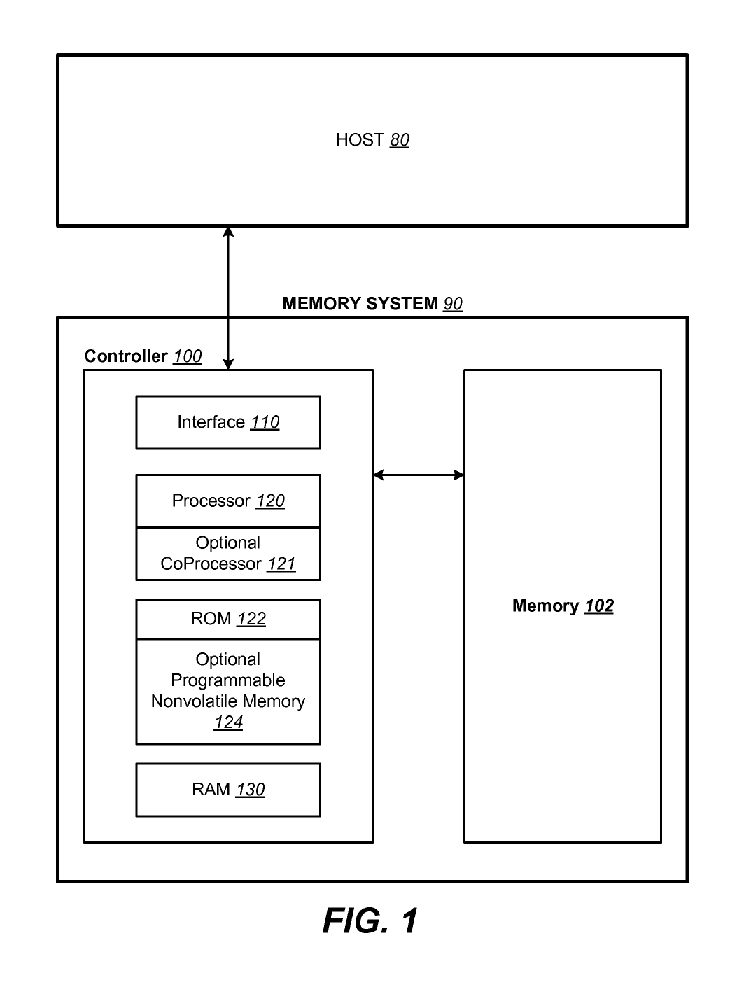

FIG. 1 illustrates schematically the main hardware components of a memory system suitable for implementing the following. The memory system 90 typically operates with a host 80 through a host interface. The memory system may be in the form of a removable memory such as a memory card, or may be in the form of an embedded memory system. The memory system 90 includes a memory 102 whose operations are controlled by a controller 100. The memory 102 comprises one or more array of non-volatile memory cells distributed over one or more integrated circuit chip. The controller 100 may include interface circuits 110, a processor 120, ROM (read-only-memory) 122, RAM (random access memory) 130, programmable nonvolatile memory 124, and additional components. The controller is typically formed as an ASIC (application specific integrated circuit) and the components included in such an ASIC generally depend on the particular application.

With respect to the memory section 102, semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure.

In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

It will be recognized that the following is not limited to the two dimensional and three dimensional exemplary structures described but cover all relevant memory structures within the spirit and scope as described herein

### Physical Memory Structure

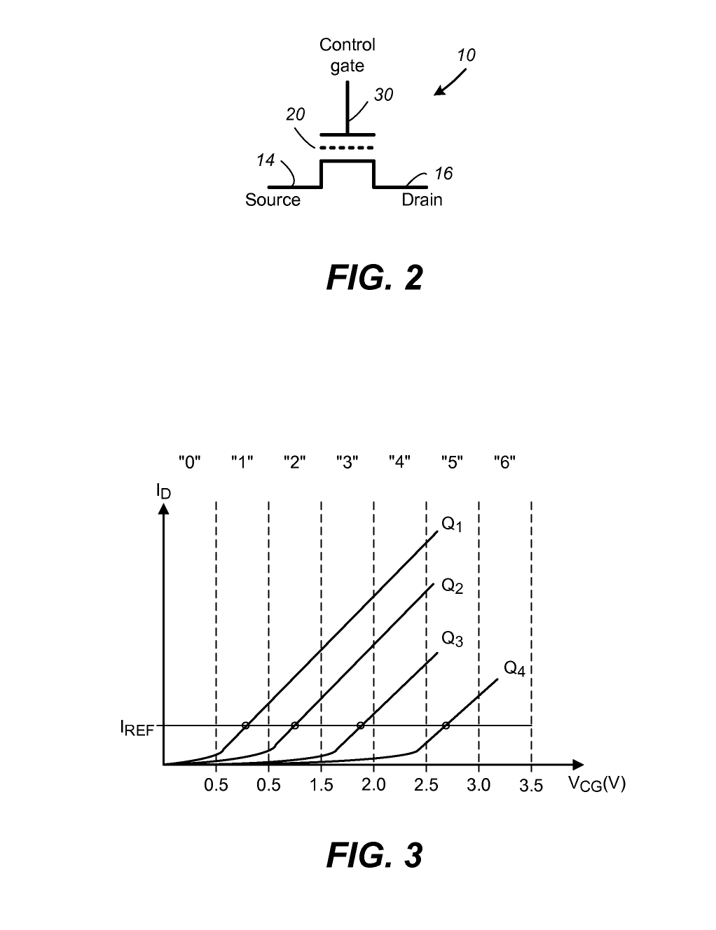

FIG. 2 illustrates schematically a non-volatile memory cell. The memory cell 10 can be implemented by a field-effect transistor having a charge storage unit 20, such as a floating gate or a charge trapping (dielectric) layer. The memory cell 10 also includes a source 14, a drain 16, and a control gate 30.

There are many commercially successful non-volatile solid-state memory devices being used today. These memory devices may employ different types of memory cells, each type having one or more charge storage element.

Typical non-volatile memory cells include EEPROM and flash EEPROM. Also, examples of memory devices utilizing dielectric storage elements.

In practice, the memory state of a cell is usually read by sensing the conduction current across the source and drain electrodes of the cell when a reference voltage is applied to the control gate. Thus, for each given charge on the floating gate of a cell, a corresponding conduction current with respect to a fixed reference control gate voltage may be detected. Similarly, the range of charge programmable onto the floating gate defines a corresponding threshold voltage window or a corresponding conduction current window.

Alternatively, instead of detecting the conduction current among a partitioned current window, it is possible to set the threshold voltage for a given memory state under test at the control gate and detect if the conduction current is lower or higher than a threshold current (cell-read reference current). In one implementation the detection of the conduction current relative to a threshold current is accomplished by examining the rate the conduction current is discharging through the capacitance of the bit line.

FIG. 3 illustrates the relation between the source-drain current I_{D} and the control gate voltage V_{CG} for four different charges Q1-Q4 that the floating gate may be selectively storing at any one time. With fixed drain voltage bias, the four solid I_{D} versus V_{CG} curves represent four of seven possible charge levels that can be programmed on a floating gate of a memory cell, respectively corresponding to four possible memory states. As an example, the threshold voltage window of a population of cells may range from 0.5V to 3.5V. Seven possible programmed memory states “0”, “1”, “2”, “3”, “4”, “5”, “6”, and an erased state (not shown) may be demarcated by partitioning the threshold window into regions in intervals of 0.5V each. For example, if a reference current, IREF of 2 μA is used as shown, then the cell programmed with Q1 may be considered to be in a memory state “1” since its curve intersects with I_{REF} in the region of the threshold window demarcated by VCG=0.5V and 1.0V. Similarly, Q4 is in a memory state “5”.

As can be seen from the description above, the more states a memory cell is made to store, the more finely divided is its threshold window. For example, a memory device may have memory cells having a threshold window that ranges from −1.5V to 5V. This provides a maximum width of 6.5V. If the memory cell is to store 16 states, each state may occupy from 200 mV to 300 mV in the threshold window. This will require higher precision in programming and reading operations in order to be able to achieve the required resolution.

### NAND Structure

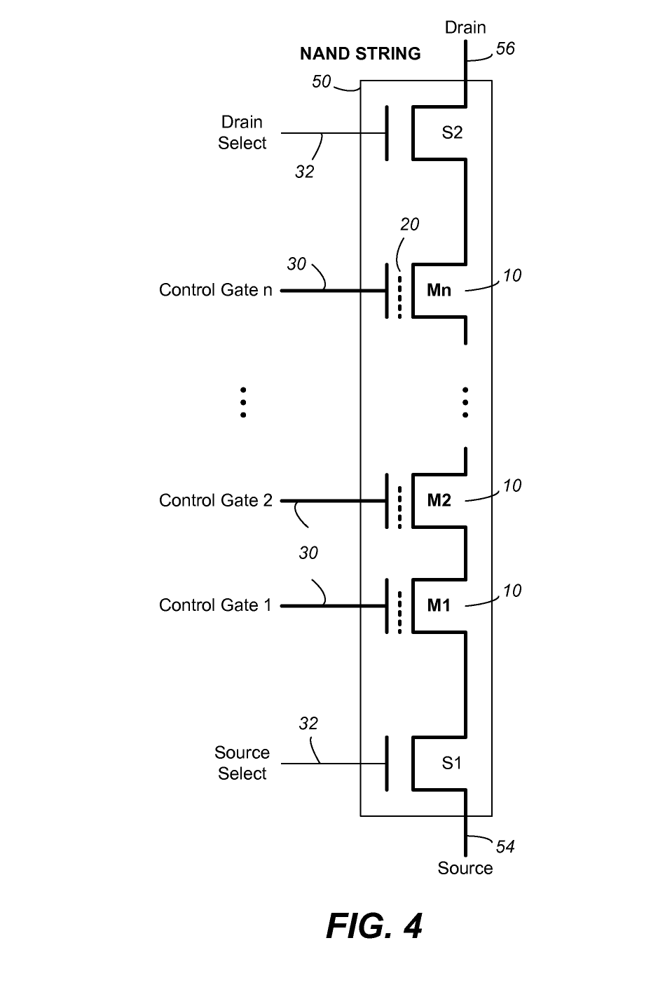

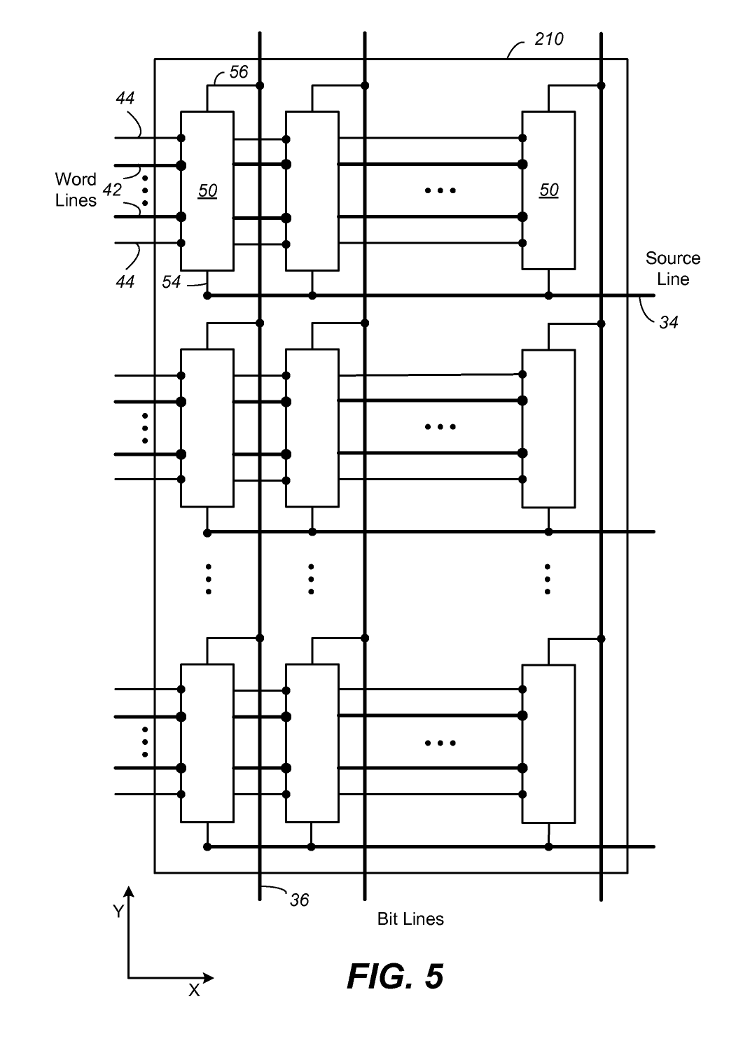

FIG. 4 illustrates schematically a string of memory cells organized into a NAND string. A NAND string 50 comprises a series of memory transistors M1, M2, . . . Mn (e.g., n=4, 8, 16 or higher) daisy-chained by their sources and drains. A pair of select transistors S1, S2 controls the memory transistor chain's connection to the external world via the NAND string's source terminal 54 and drain terminal 56 respectively. In a memory array, when the source select transistor S1 is turned on, the source terminal is coupled to a source line (see FIG. 5). Similarly, when the drain select transistor S2 is turned on, the drain terminal of the NAND string is coupled to a bit line of the memory array. Each memory transistor 10 in the chain acts as a memory cell. It has a charge storage element 20 to store a given amount of charge so as to represent an intended memory state. A control gate 30 of each memory transistor allows control over read and write operations. As will be seen in FIG. 5, the control gates 30 of corresponding memory transistors of a row of NAND string are all connected to the same word line. Similarly, a control gate 32 of each of the select transistors S1, S2 provides control access to the NAND string via its source terminal 54 and drain terminal 56 respectively. Likewise, the control gates 32 of corresponding select transistors of a row of NAND string are all connected to the same select line.

When an addressed memory transistor 10 within a NAND string is read or is verified during programming, its control gate 30 is supplied with an appropriate voltage. At the same time, the rest of the non-addressed memory transistors in the NAND string 50 are fully turned on by application of sufficient voltage on their control gates. In this way, a conductive path is effectively created from the source of the individual memory transistor to the source terminal 54 of the NAND string and likewise for the drain of the individual memory transistor to the drain terminal 56 of the cell.

FIG. 5 illustrates an example of a NAND array 210 of memory cells, constituted from NAND strings 50 such as that shown in FIG. 4. Along each column of NAND strings, a bit line such as bit line 36 is coupled to the drain terminal 56 of each NAND string. Along each bank of NAND strings, a source line such as source line 34 is coupled to the source terminals 54 of each NAND string. Also the control gates along a row of memory cells in a bank of NAND strings are connected to a word line such as word line 42. The control gates along a row of select transistors in a bank of NAND strings are connected to a select line such as select line 44. An entire row of memory cells in a bank of NAND strings can be addressed by appropriate voltages on the word lines and select lines of the bank of NAND strings.

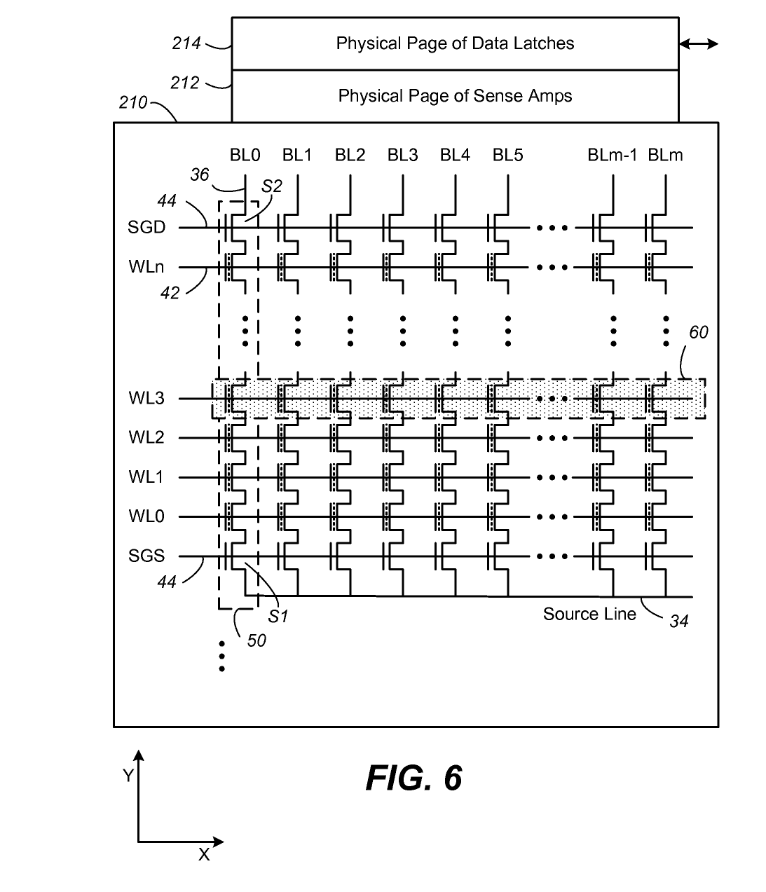

FIG. 6 illustrates a page of memory cells, organized in the NAND configuration, being sensed or programmed in parallel. FIG. 6 essentially shows a bank of NAND strings 50 in the memory array 210 of FIG. 5, where the detail of each NAND string is shown explicitly as in FIG. 4. A physical page, such as the page 60, is a group of memory cells enabled to be sensed or programmed in parallel. This is accomplished by a corresponding page of sense amplifiers 212. The sensed results are latched in a corresponding set of latches 214. Each sense amplifier can be coupled to a NAND string via a bit line. The page is enabled by the control gates of the cells of the page connected in common to a word line 42 and each cell accessible by a sense amplifier accessible via a bit line 36. As an example, when respectively sensing or programming the page of cells 60, a sensing voltage or a programming voltage is respectively applied to the common word line WL3 together with appropriate voltages on the bit lines.

### Physical Organization of the Memory

One difference between flash memory and other of types of memory is that a cell is programmed from the erased state. That is, the floating gate is first emptied of charge. Programming then adds a desired amount of charge back to the floating gate. It does not support removing a portion of the charge from the floating gate to go from a more programmed state to a lesser one. This means that updated data cannot overwrite existing data and is written to a previous unwritten location.

Furthermore erasing is to empty all the charges from the floating gate and generally takes appreciable time. For that reason, it will be cumbersome and very slow to erase cell by cell or even page by page. In practice, the array of memory cells is divided into a large number of blocks of memory cells. As is common for flash EEPROM systems, the block is the unit of erase. That is, each block contains the minimum number of memory cells that are erased together. While aggregating a large number of cells in a block to be erased in parallel will improve erase performance, a large size block also entails dealing with a larger number of update and obsolete data.

Each block is typically divided into a number of physical pages. A logical page is a unit of programming or reading that contains a number of bits equal to the number of cells in a physical page. In a memory that stores one bit per cell, one physical page stores one logical page of data. In memories that store two bits per cell, a physical page stores two logical pages. The number of logical pages stored in a physical page thus reflects the number of bits stored per cell. In one embodiment, the individual pages may be divided into segments and the segments may contain the fewest number of cells that are written at one time as a basic programming operation. One or more logical pages of data are typically stored in one row of memory cells. A page can store one or more sectors. A sector includes user data and overhead data.

### All-Bit, Full-Sequence MLC Programming

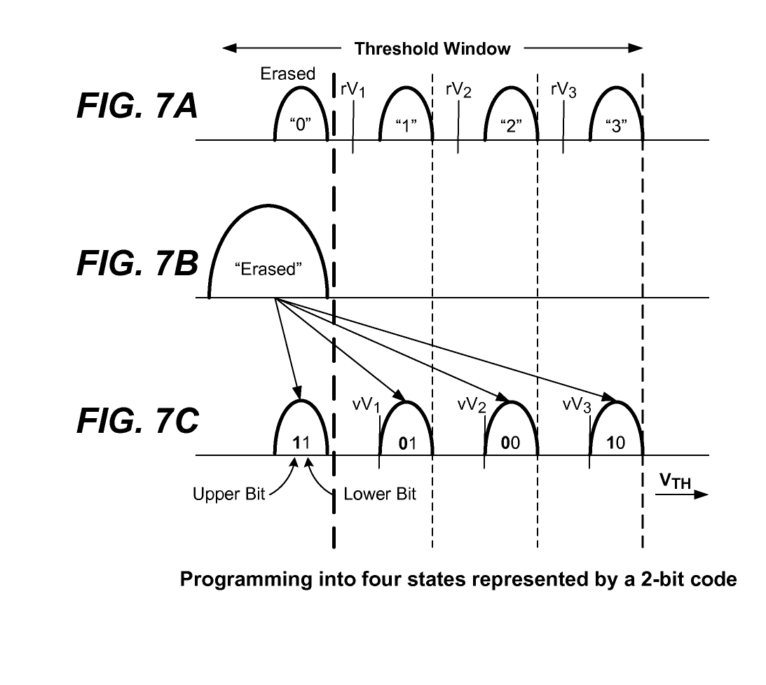

FIG. 7A-7C illustrate an example of programming a population of 4-state memory cells. FIG. 7A illustrates the population of memory cells programmable into four distinct distributions of threshold voltages respectively representing memory states “0”, “1”, “2” and “3”. FIG. 7B illustrates the initial distribution of “erased” threshold voltages for an erased memory. FIG. 6C illustrates an example of the memory after many of the memory cells have been programmed. Essentially, a cell initially has an “erased” threshold voltage and programming will move it to a higher value into one of the three zones demarcated by verify levels vV₁, vV₂ and vV₃. In this way, each memory cell can be programmed to one of the three programmed states “1”, “2” and “3” or remain un-programmed in the “erased” state. As the memory gets more programming, the initial distribution of the “erased” state as shown in FIG. 7B will become narrower and the erased state is represented by the “0” state.

A 2-bit code having a lower bit and an upper bit can be used to represent each of the four memory states. For example, the “0”, “1”, “2” and “3” states are respectively represented by “11”, “01”, “00” and ‘10”. The 2-bit data may be read from the memory by sensing in “full-sequence” mode where the two bits are sensed together by sensing relative to the read demarcation threshold values rV₁, rV₂ and rV₃ in three sub-passes respectively.

### 3-D NAND Structures

An alternative arrangement to a conventional two-dimensional (2-D) NAND array is a three-dimensional (3-D) array. In contrast to 2-D NAND arrays, which are formed along a planar surface of a semiconductor wafer, 3-D arrays extend up from the wafer surface and generally include stacks, or columns, of memory cells extending upwards. Various 3-D arrangements are possible. In one arrangement a NAND string is formed vertically with one end (e.g. source) at the wafer surface and the other end (e.g. drain) on top. In another arrangement a NAND string is formed in a U-shape so that both ends of the NAND string are accessible on top, thus facilitating connections between such strings.

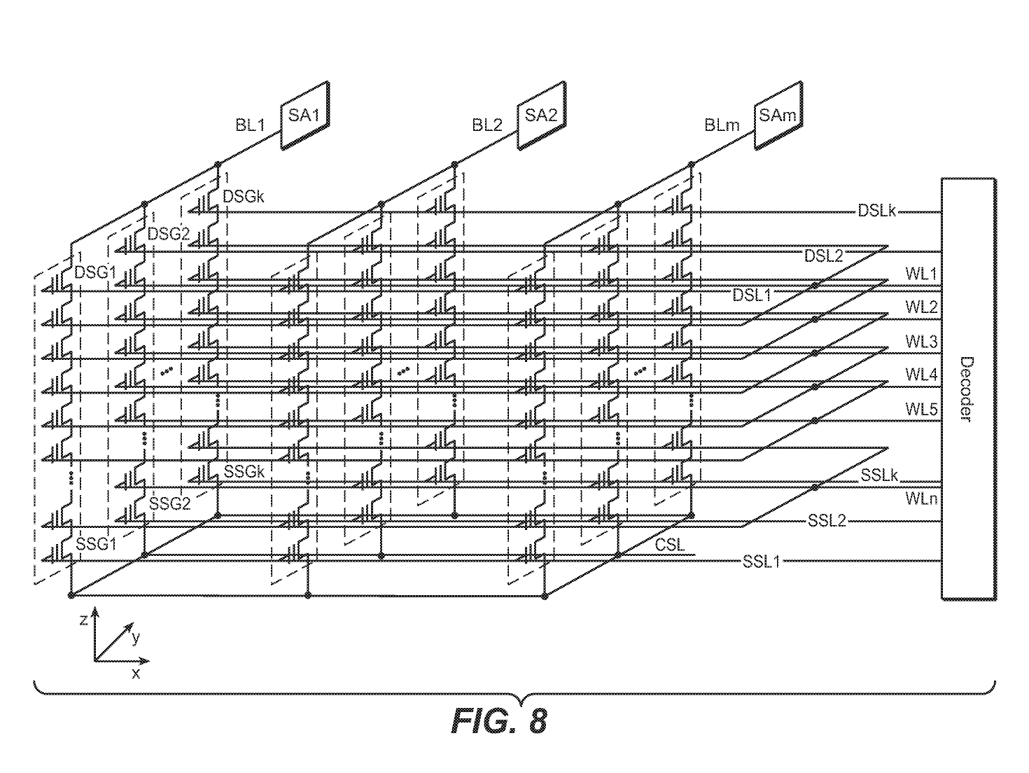

FIG. 8 shows a first example of a NAND string 701 that extends in a vertical direction, i.e. extending in the z-direction, perpendicular to the x-y plane of the substrate. Memory cells are formed where a vertical bit line (local bit line) 703 passes through a word line (e.g. WL0, WL1, etc.). A charge trapping layer between the local bit line and the word line stores charge, which affects the threshold voltage of the transistor formed by the word line (gate) coupled to the vertical bit line (channel) that it encircles. Such memory cells may be formed by forming stacks of word lines and then etching memory holes where memory cells are to be formed. Memory holes are then lined with a charge trapping layer and filled with a suitable local bit line/channel material (with suitable dielectric layers for isolation).

As with planar NAND strings, select gates 705, 707, are located at either end of the string to allow the NAND string to be selectively connected to, or isolated from, external elements 709, 711. Such external elements are generally conductive lines such as common source lines or bit lines that serve large numbers of NAND strings. Vertical NAND strings may be operated in a similar manner to planar NAND strings and both SLC and MLC operation is possible. While FIG. 8 shows an example of a NAND string that has 32 cells (0-31) connected in series, the number of cells in a NAND string may be any suitable number. Not all cells are shown for clarity. It will be understood that additional cells are formed where word lines 3-29 (not shown) intersect the local vertical bit line.

A 3D NAND array can, loosely speaking, be formed tilting up the respective structures 50 and 210 of FIGS. 5 and 6 to be perpendicular to the x-y plane. In this example, each y-z plane corresponds to the page structure of FIG. 6, with m such plane at differing x locations. The (global) bit lines, BL1-m, each run across the top to an associated sense amp SA1-m. The word lines, WL1-n, and source and select lines SSL1-n and DSL1-n, then run in x direction, with the NAND string connected at bottom to a common source line CSL.

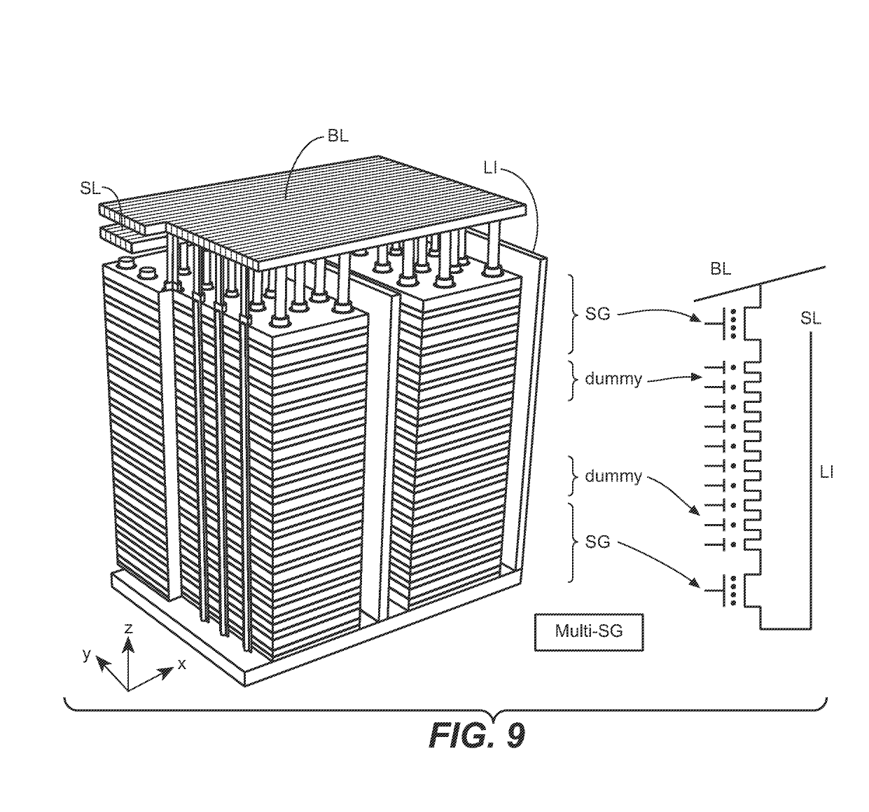

FIGS. 9-12 look at a particular monolithic three dimensional (3D) memory array of the NAND type (more specifically of the “BiCS” type), where one or more memory device levels are formed above a single substrate, in more detail. FIG. 9 is an oblique projection of part of such a structure, showing a portion corresponding to two of the page structures in FIG. 5, where, depending on the embodiment, each of these could correspond to a separate block or be different “fingers” of the same block. Here, instead to the NAND strings lying in a common y-z plane, they are squashed together in the y direction, so that the NAND strings are somewhat staggered in the x direction. On the top, the NAND strings are connected along global bit lines (BL) spanning multiple such sub-divisions of the array that run in the x direction. Here, global common source lines (SL) also run across multiple such structures in the x direction and are connect to the sources at the bottoms of the NAND string, which are connected by a local interconnect (LI) that serves as the local common source line of the individual finger. Depending on the embodiment, the global source lines can span the whole, or just a portion, of the array structure. Rather than use the local interconnect (LI), variations can include the NAND string being formed in a U type structure, where part of the string itself runs back up.

To the right of FIG. 9 is a representation of the elements of one of the vertical NAND strings from the structure to the left. Multiple memory cells are connected through a drain select gate SGD to the associated bit line BL at the top and connected through the associated source select gate SDS to the associated local source line LI to a global source line SL. It is often useful to have a select gate with a greater length than that of memory cells, where this can alternately be achieved by having several select gates in series (as described in U.S. patent application Ser. No. 13/925,662, filed on Jun. 24, 2013), making for more uniform processing of layers. Additionally, the select gates are programmable to have their threshold levels adjusted. This exemplary embodiment also includes several dummy cells at the ends that are not used to store user data, as their proximity to the select gates makes them more prone to disturbs.

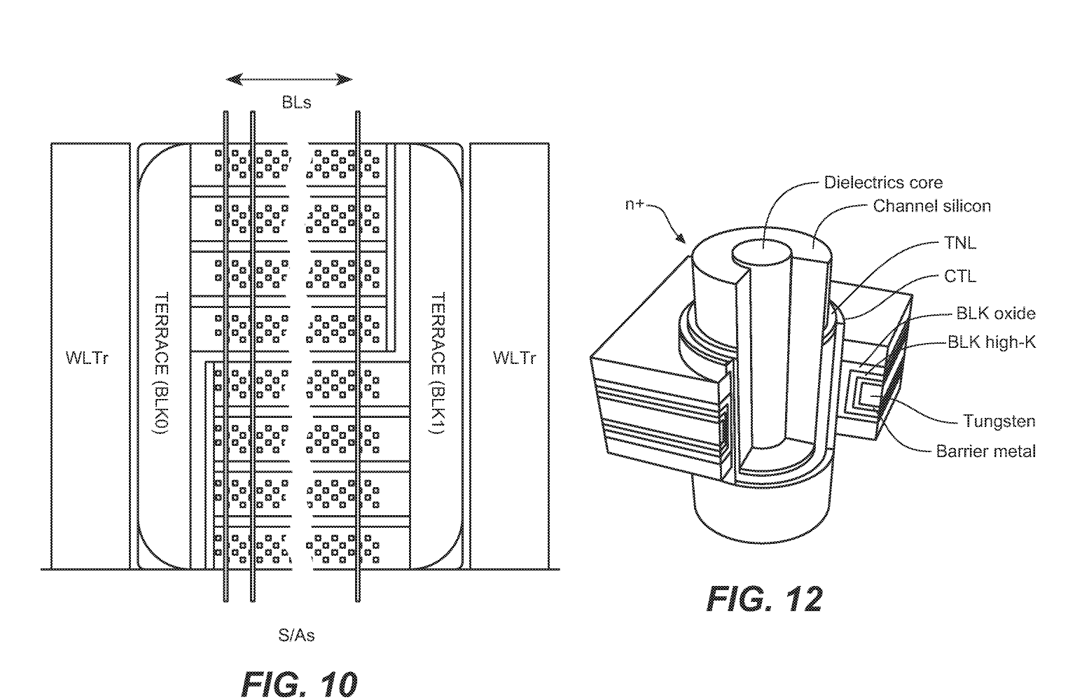

FIG. 10 shows a top view of the structure for two blocks in the exemplary embodiment. Two blocks (BLK0 above, BLK1 below) are shown, each having four fingers that run left to right. The word lines and select gate lines of each level also run left to right, with the word lines of the different fingers of the same block being commonly connected at a “terrace” and then on to receive their various voltage level through the word line select gates at WLTr. The word lines of a given layer in a block can also be commonly connected on the far side from the terrace. The selected gate lines can be individual for each level, rather common, allowing the fingers to be individually selected. The bit lines are shown running up and down the page and connect on to the sense amp circuits, where, depending on the embodiment, each sense amp can correspond to a single bit line or be multiplexed to several bit lines.

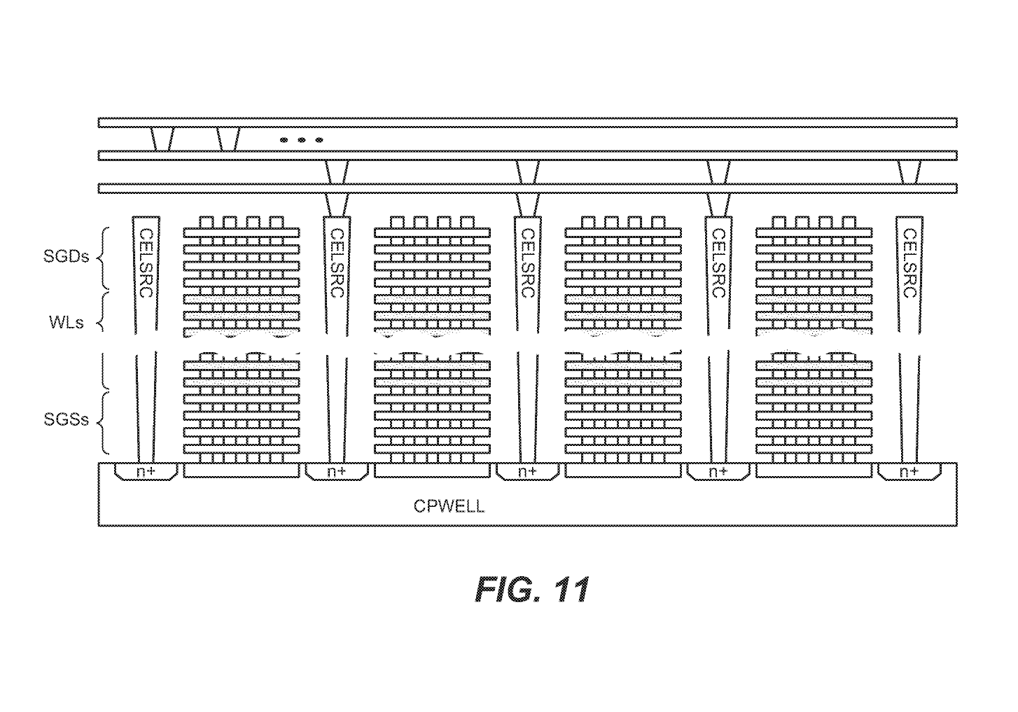

FIG. 11 shows a side view of one block, again with four fingers. In this exemplary embodiment, the select gates SGD and SOS at either end of the NAND strings are formed of four layers, with the word lines WL in-between, all formed over a CPWELL. A given finger is selected by setting its select gates to a level VSG and the word lines are biased according to the operation, such as a read voltage (VCGRV) for the selected word lines and the read-pass voltage (VREAD) for the non-selected word lines. The non-selected fingers can then be cut off by setting their select gates accordingly.

FIG. 12 illustrates some detail of an individual cell. A dielectric core runs in the vertical direction and is surrounded by a channel silicon layer, that is in turn surrounded a tunnel dielectric (TNL) and then the charge trapping dielectric layer (CTL). The gate of the cell is here formed of tungsten with which is surrounded by a metal barrier and is separated from the charge trapping layer by blocking (BLK) oxide and a high K layer.

### Re-Ordering of Commands for Optimizing Throughput

The next sections look further at the issuance of commands to the memory circuits, whether this is done in the controller circuit (100, FIG. 1) of the memory system, from the host, or split between the two. More specifically, this section considers techniques related to the order of these commands to improve throughput in non-volatile memory systems. As noted in the Background, a host issues commands to a NAND storage device (such as a solid state drive (SSD), memory card, or embedded flash memory) without knowledge of the internals of said device, which can result in read/write traffic being unevenly distributed among various dies/planes/chips within the memory system, keeping some dies/planes/chips busier than others, reducing the overall throughput. This section looks at techniques to keep the different independent-NAND-access-channels busy even when the traffic from the host is not arriving evenly. A subsequent section looks at guaranteeing a certain level of performance, termed as Quality-Of-Service (QoS), that is both a differentiating advantage and requirement when NAND storage is used in the enterprise/cloud markets.

NAND flash is typically arranged as stacked dies within an integrated circuit package. Each die is further organized as planes, each plane containing a memory-array addressable as a set of [dies, planes, blocks, pages]. Read/Write/Erase commands are addressed to the aforementioned 4-tuple. For instance, [0,0,26,32] is a 4-tuple addressed to die 0, plane 0, block 26, page 32.

A host computer/controller usually sees NAND Flash as a contiguous set of logical addresses, exposed via an interconnect standard like PCIE or SATA, often called the front-end of a NAND storage device. A Flash Translation Layer (FTL) translates read/write commands issued to logical addresses (LBAs) into physical address (PBAs). The techniques described here pertain to traffic from the FTL, which is addressed to PBAs.

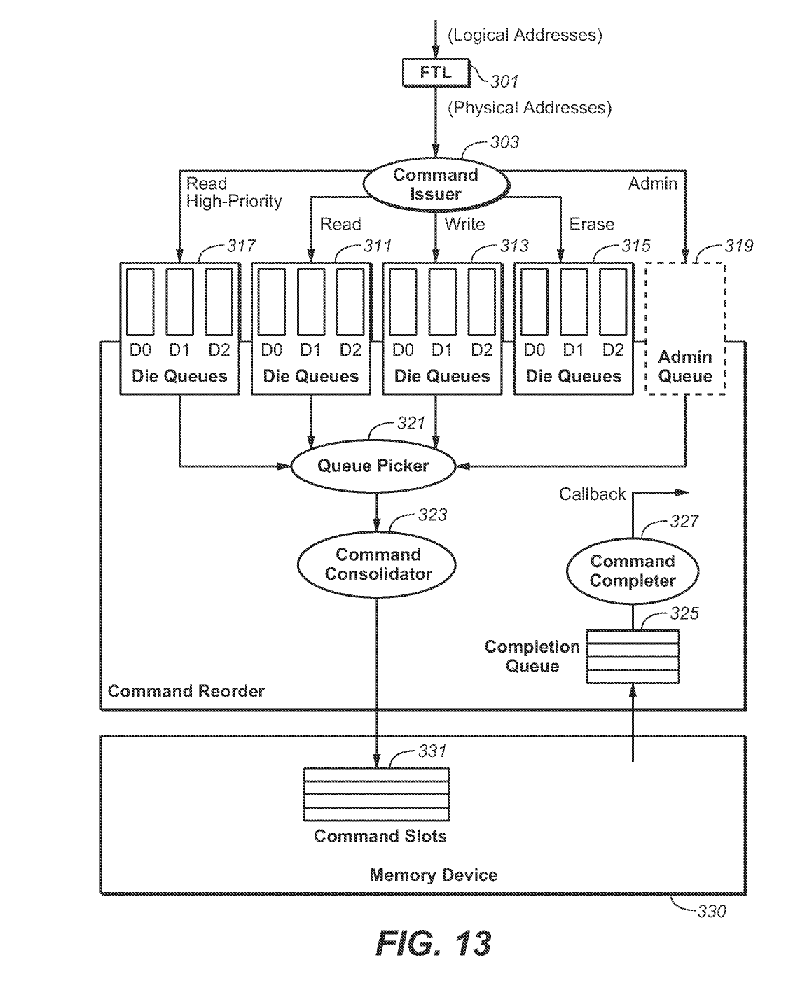

FIG. 13 provides a system overview of an exemplary embodiment. Incoming commands from the FTL 301 for a device (device is a group of dies) are directed by the command issuer 303 to separate queues for admin (device management) 319, read 311, write 313, erase 315 and, in this example, high-priority reads 319. An admin queue 319, which typically has the highest priority among all queues, allows for the issuance of management commands, like those related to power management, firmware downloading, reset, etc. The designation of commands as high-priority is typically done at a layer above the command issuer, such as in the file system or file translation layer 301. Separate queues allow non-interference of commands without dependency, providing higher throughput compared to previous approaches.

A queue-picker 321 switches between various command queues based on a chain-length parameter. For instance, the system may choose to execute, say, 300 read commands, before switching to the write-queues, whose chain-length, for instance is 30. 300 and 30 were picked on account of writes often being ten times longer than reads for 2-bit per cell memory arrangements. For commands with dependency, an in-band SYNC command is inserted, forcing a queue-switch (say from read to write queues). (A sync command is a non-admin command used to ‘synchronize’ all queues to a known state, where some more detailed explanation in later sections.)

The individual read, write and erase queues for a device can be further divided into die-based queues (D0, D1, D2). Once a queue is picked, say the read-queue, one command can be picked from each die queue, and send to a command-consolidator 323. The command-consolidator logic will combine commands to achieve multi-plane operation, if possible. Otherwise, it may still combine commands in ways that allow for optimal utilization of caching in NAND. The consolidated command sequences are then sent on to the memory system 300, when the command slots are then shown at 331. The memory section can contain multiple (e.g. 8 or 16) devices, each with a controller and memory chips. Coming back from the memory section is then a completion queue 325 and command completer 327 to provide any callback. This arrangement can accommodate both commands originating from the host, as well as those operations originating within the memory system, such as garbage collection or other housekeeping operations, although in this case the data need not be transferred out of the memory and the higher levels just need to be aware of the operations.

The portions of FIG. 13 can be distributed in various combinations between the host and controller. For example, in FIG. 13, in the memory device section 330, the devices can include a NAND flash controller that manages a group of dies, performs ECC and assists in optimally issuing raw-NAND commands. In one implementation, the command-consolidation is implemented both in the host, as well as in firmware in the controller. However the techniques are applicable to any flash memory storage device, like a solid state drive (SSD) or SD or other memory card. Further, the implementation of the logic can reside in the controller, or in host, or a combination of the two. In the case of controller, the capabilities could be provided with the device. For a host, this can be a host software module in the form of a driver, or other package.

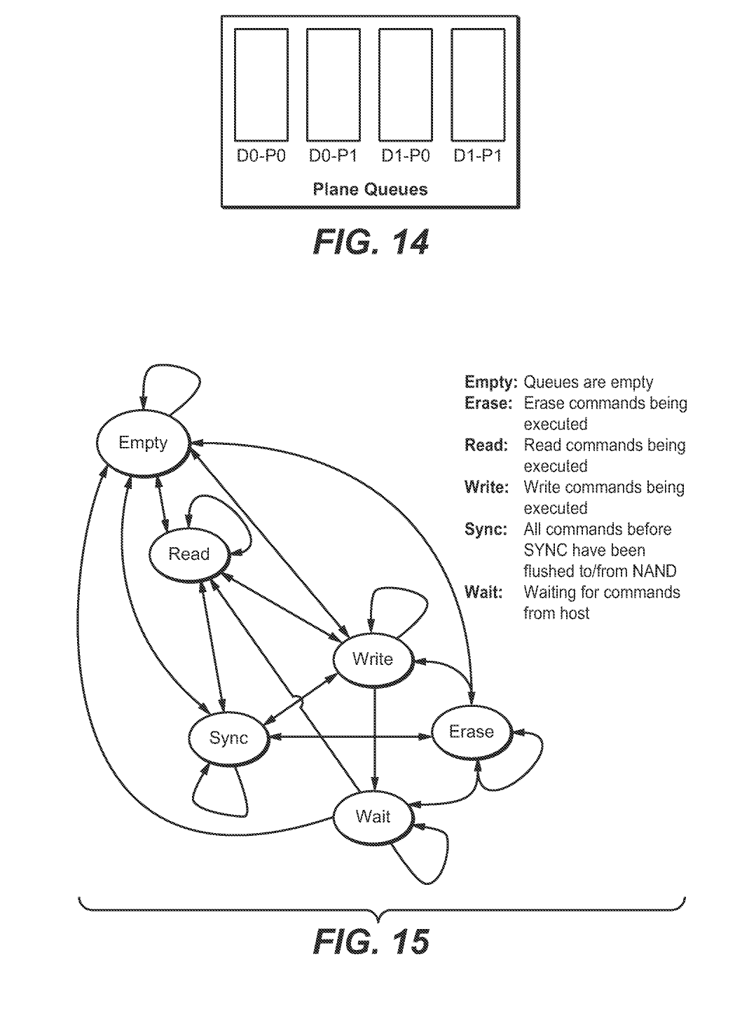

Although FIG. 13 further breaks down the command-queues into die-based queues, an alternate implementation might have queues on a per plane basis, as shown in FIG. 14. FIG. 14 shows a command queue (say read queue) organized as individual plane queues.

The queue picker 321 can select the active request queue based on a state machine, shown as that shown in FIG. 15. There is one active request queue at a time. If the active request queue is a read queue, read commands can be pulled from the appropriate die queues in a round-robin fashion, and provided to the command-consolidation block 323, which issues the command to memory section 330. In general, queue picker can run reads, writes and erases separately as batches unless it encounters a SYNC primitive, or hits a predefined chain-length limit. A SYNC is inserted to each die queue, which forces a queue to be suspended and switched even if the chain-length has not been reached. When all queues are in sync, no further I/Os are issued, until the SYNC is de-asserted.

### In-Band SYNC

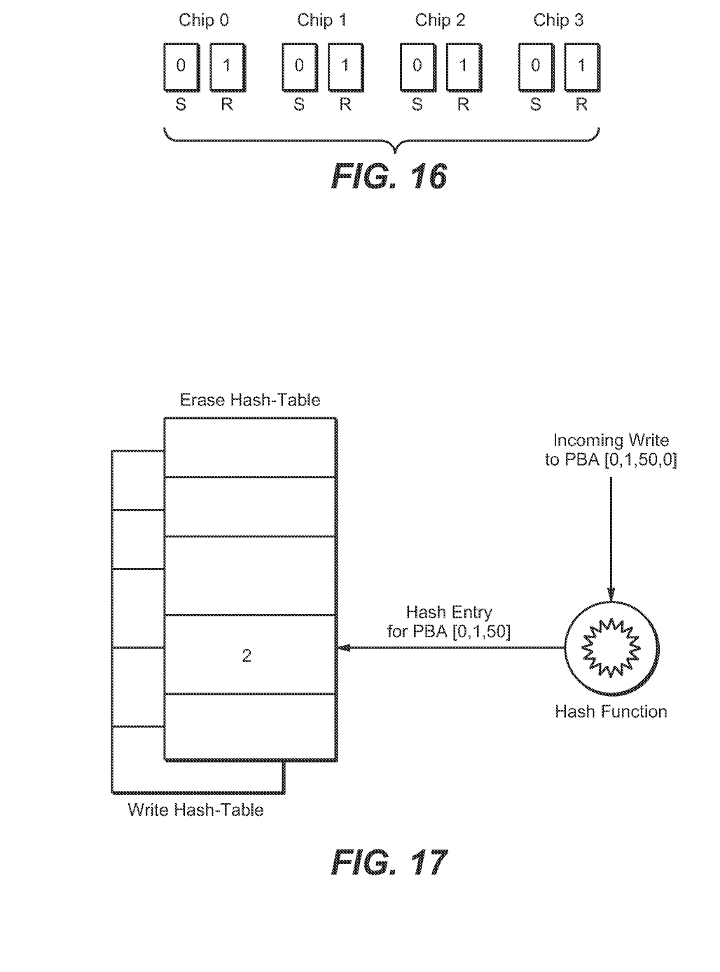

As described in the previous section, a SYNC forces a queue-switch, until all command queues are in sync. Synchronization primitives can be handled by maintaining a set of flags. FIG. 16 considers a system with four devices (four chips). For each chip, there is a sync bit “S” and a release bit “R.” The figure depicts the data structures for a single primitive.

A sync primitive is inserted to ensure read-after-write or write-after-erase coherency. The exemplary embodiment maintains a set of two hash tables to keep track of the physical block addresses (PBAs) of commands pending completion. The first hash table corresponds to pending erase commands, and the second to pending write commands. An incoming write or erase command's PBA is passed through a hash function, which points to a location in the corresponding hash table. The entry in the table corresponds to the count of commands issued to the said PBA. Every incoming command increments the count, and completion decrements the count.

In FIG. 17, a write command to [die, plane, block, page]=[0, 1, 50, 0] arrives from the FTL to the command-reorder layer. A look-up is performed on the erase hash table, finding 2 pending erases on [die, plane, block]=[0, 1, 50]. Prior to inserting the write command in the appropriate queue, a SYNC is inserted to all queues. The SYNC guarantees the completion of all previously issued commands, thereby ensuring the completion of the 2 pending erases. Also, the corresponding entry in the write hash-table is incremented. Similarly, the PBA of a read command is checked against the erase and write hash tables. If either is a non-zero entry, a SYNC is inserted.

### Details on the Principles of Reordering

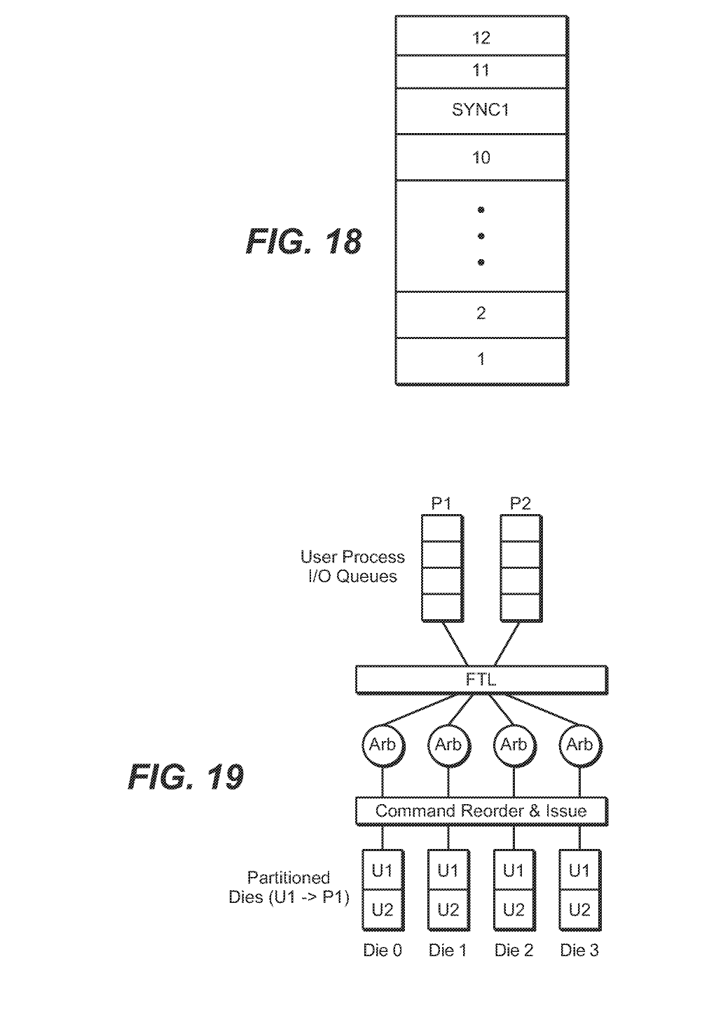

Commands addressed to physical addresses are reordered. An exceptions is that commands can only be re-ordered within SYNC boundaries. In FIG. 18 commands 1-10 occur prior to SYNC1. Hence, command #10 can be executed (reordered) prior to #1. However, command #11, which is issued after SYNC1 is not allowed to be executed/reordered prior to the execution of commands 1-10. (The insertion of SYNC is explained above.) Thus, as shown in FIG. 18, commands 1-10 are allowed to be reordered between themselves but 11, 12 . . . cannot be executed prior to 1-10. Commands 11, 12 . . . can however be reordered among themselves.

A special case of SYNC insertion is worthy of mention here. Commands of the same type (for example reads) can be reordered without restriction within SYNC boundaries. However, commands of different types (say reads and writes) can only be re-ordered if there is no dependency between them. For instance, a read to [die, plane, block, page]=[0,1,356,56] cannot be executed prior to a write issued to the same address. (The scheme to check for such collisions using hash tables has been explained above.)

### Quality-of-Service Specification

In commercially available commodity block storage, the service provider may provide QoS (quality-of-service) guarantees on the performance and availability of the storage. The QoS is codified in an SLA (service-level agreement) describing the guarantees in numerical terms. One example of commodity block storage is Amazon EBS (elastic block store). Amazon EBS can be used to provide a storage infrastructure to additional web services from Amazon. Therefore, from the perspective of the web service, EBS is local storage. Amazon publishes an SLA which governs the performance of EBS.

Existing implementations of QoS in literature and products view flash storage as block devices addressable via LBAs (Logical Block Address). QoS methods applied to LBAs, while still practical, may not be the most optimal solution for flash devices. One reason is because contiguous LBAs represent sequential access in disk drives, but, in multi-threaded hosts with multiple streams operating on a flash device, contiguous LBAs may, in the worst case, be serializing the operations onto a single die. Another reason is that since the LBA to PBA mapping is hidden from the host, QoS algorithms aiming to schedule LBAs in whatever fashion them deem beneficial, may not yield the expected gains in Flash.

The FTL layer, on account of access to information (enumerated above) hidden from the host is most suited for optimizing and guaranteeing I/O access times. An exemplary embodiment of this section implements the FTL and command-reordering on the host, which allows for extra information (listed below) about the I/Os to be passed along with the command. If the flash storage interface allows for extra-information to be added to standard commands, these can later be exploited by the QoS layer. For example, FileSystem meta-data I/O can be detected, and routed to the priority read queues. This accelerates I/O as the host uses the FileSystem I/O to decode the LBAs of the ‘data’ section of a file. A unique weight parameter can also be associated with every unique requestor. When I/Os are competing for the same [device, die, plane], ones with a higher weight parameter get scheduled earlier. This parameter maps directly to the end application requesting it from the host.

FIG. 19 illustrates implementing QoS in terms of physical addresses at the PBA level. U1 and U2 are partitions of Die 0-3 created for two user applications/processes, P1 and P2. Requests from a user application contain a marker indicating the originator. This marker is used by the Arbiter (shown as Arb in the figure) to enforce QoS. For instance, if P1 is promised 60% of the IOPS offered by the device, the Arbiter ensures a 60:40 ratio in I/Os scheduled to the same [device, die, plane].

### CONCLUSION

The techniques described in the preceding sections have a number of advantages and useful properties. Having separate queues for reads, writes and erases allow for commands without dependency to execute independent of the order of arrival. Batch execution of each queue allows for higher utilization of NAND caching/multi-plane operations, increasing throughput.

Separate queues per die allow for a scheme that keeps all dies busy (if commands are available for the said die), even though traffic from the host arrived in a different, non-optimal order. The die-queues also reduce computation time for command-reordering. The computation required to fetch a command for a given die includes checking if the relevant queue is non-empty, and de-queuing from the head of the queue.

The use of in-band SYNC commands helps in maintaining read-after-write and write-after-erase coherency, even though incoming commands are being actively re-ordered. Additionally, the use of hash-tables and a hash-function to monitor pending commands reduces computation time, and RAM resources. This design is scalable to very large command queue depths while keeping computation time and RAM usage low.

QoS performed on PBAs vs LBAs offers a more accurate scheme for controlling access to a common storage resource by multiple applications.

The foregoing detailed description has been presented for purposes of illustration and description. It is not intended to be exhaustive or to limit the above to the precise form disclosed. Many modifications and variations are possible in light of the above teaching. The described embodiments were chosen in order to explain the principles involved and its practical application, to thereby enable others to best utilize the various embodiments and with various modifications as are suited to the particular use contemplated. It is intended that the scope be defined by the claims appended hereto.

It is claimed:

1. A method of operating a non-volatile memory system including one or more non-volatile flash memory circuits, comprising:
receiving a series of commands each specifying a physical address on the non-volatile memory, the series of commands including read, write and erase commands for the specified physical addresses;
arranging the received series of commands into a plurality of queues for execution thereof, wherein separate queues are maintained for read commands, write commands, and erase commands;
selecting sequences of commands to execute from the plurality of queues, where only one of the queue is active at a time; and
transmitting the sequences to the one or more non-volatile memory circuits to be executed therein.

2. The method of claim 1, wherein the non-volatile system includes a plurality of dies and separate queues are maintained for each die for each of read commands, write commands, and erase commands.

3. The method of claim 1, wherein the non-volatile system includes a plurality of memory chips and separate queues are maintained for each chip for each of read commands, write commands, and erase commands.

4. The method of claim 1, wherein one or more of the memory circuits include multiple planes and separate queues are maintained for each of the planes for each of read commands, write commands, and erase commands.

5. The method of claim 1, wherein the memory system includes one or more controller circuits each connected to one or more of the non-volatile flash memory circuits, the memory system being connected to a host device and wherein the receiving, arranging, selecting, and transmitting are performed by the host.

6. The method of claim 4, wherein the memory circuits are part of a non-volatile memory system including a controller circuit to which the host transmits the sequences

7. The method of claim 1, wherein the memory system includes a controller circuits connected to the non-volatile flash memory circuits, and wherein the receiving, arranging, selecting, and transmitting are performed by the controller circuit.

8. The method of claim 1, wherein the memory system includes one or more controller circuits each connected to one or more of the non-volatile flash memory circuits, the memory system being connected to a host device and wherein the receiving, arranging, selecting, and transmitting operations are distributed between the host and one or more of the controller circuits.

9. The method of claim 1, wherein receiving the series of commands each specifying a physical address on the non-volatile memory includes:
receiving the series of commands expressed in terms of logical addresses; and
translating the logical addresses into corresponding physical addresses.

10. The method of claim 1, wherein one or more of the commands are received from a host to which the memory system is connected.

11. The method of claim 1, wherein one or more of the commands are originated from within the memory system.

12. The method of claim 1, where in the plurality of queues further includes a priority queue in which are maintained commands specified as being of a higher priority.

13. The method of claim 1, wherein arranging the received series of commands into a plurality of queues includes inserting synchronization entries into the queues to maintain command coherence between the queues.

14. The method of claim 13, wherein arranging the received series of commands includes determining whether the specified physical address for a first command has a pending conflicting operation thereto and inserting a corresponding synchronization entry into the corresponding queue.

15. The method of claim 14, wherein determining whether the specified physical address for the first command has a pending conflicting operation thereto includes:
checking the specified physical address for the first command against a hash table of pending commands.

16. The method of claim 14, wherein the arranging of the received series commands re-orders commands of the queues only between synchronizing entries.

17. The method of claim 1, wherein the one or more non-volatile memory circuits are monolithic two-dimensional semiconductor memory devices with memory cells arranged in single physical level above a silicon substrate and comprise a charge storage medium.

18. The method of claim 1, wherein the one or more non-volatile memory circuits are monolithic three-dimensional semiconductor memory devices with memory cells arranged in multiple physical levels above a silicon substrate and comprise a charge storage medium.

19. A method of operating a non-volatile memory system to provide access for a plurality of user applications to a non-volatile data storage section, comprising:
receiving from the plurality of user applications requests for accessing corresponding user partitions of the data storage section as assigned by the memory system, wherein each of the user applications has a specified level of performance and availability for the accessing the corresponding user partition, and wherein the user application requests are specified in terms of corresponding logical addresses;
translating the specification of the user application requests in terms of corresponding logical addresses to be expressed in terms of corresponding physical addresses for the non-volatile data storage section;
arbitrating between requests from different ones of the user applications based upon the requests' corresponding physical addresses and corresponding specified levels of performance and availability to determine an order in which to execute the user application requests; and
issuing instructions for the execution of the user application requests based upon the determined order.

20. The method of claim 19, wherein the requests include data read requests.

21. The method of claim 19, wherein the requests include data write requests.

22. The method of claim 19, wherein the requests include erase requests.

23. The method of claim 19, wherein the arbitrating include resolving requests from differing user applications for access to conflicting physical addresses based upon the differing user applications corresponding specified levels of performance and availability.

24. The method of claim 23, wherein data storage section includes a plurality of independently accessible sub-sections and the conflicting physical addresses are for the same sub-section, the resolving being based on the relative levels of the corresponding specified levels of performance and availability.

25. The method of claim 19, wherein the specified levels of performance and availability includes a weight parameter assigned for each user application upon which the arbitration is based.

26. The method of claim 19, wherein the arbitrating between requests includes re-ordering the sequence in which the requests are issued.

27. The method of claim 19, wherein content is stored in the data storage section according to a file system and the arbitrating between requests is further based upon meta-data associated with the content.

28. The method of claim 19, wherein the non-volatile data storage section comprises monolithic two-dimensional semiconductor memory devices with memory cells arranged in single physical level above a silicon substrate and comprise a charge storage medium.

29. The method of claim 19, wherein the non-volatile data storage section comprises monolithic three-dimensional semiconductor memory devices with memory cells arranged in multiple physical levels above a silicon substrate and comprise a charge storage medium.
